(19) United States
(12) Patent Application Publication
(10) Pub. No.: US 2014/0241006 A1
(43) Pub. Date: Aug. 28, 2014

(54) LIGHT PLATE ASSEMBLY

(71) Applicant: DAKKOTA LIGHTING TECHNOLOGIES LLC, Rochester, MI (US)

(72) Inventor: Mark Licatovich, Oxford, MI (US)

(73) Assignee: DAKKOTA LIGHTING TECHNOLOGIES LLC, Rochester, MI (US)

(21) Appl. No.: 13/779,996

(22) Filed: Feb. 28, 2013

(51) Int. Cl. F21V 8/00

(52) U.S. Cl. CPC G02B 6/0073
USPC 362/612

(57) ABSTRACT

A light plate assembly having minimal light leakage and uniform luminosity. The light plate assembly has a housing, a trough within the housing and a cover. The cover has a transparent window with an opaque side edge that prevents undesired light leakage between an outer surface of the transparent window and a base frame of the cover. The transparent window also has a length and a width, and a length-to-width ratio of greater than 10:1. In addition, luminosity variation along a length of the transparent window is less than 20%, and in some instances less than 10%.

### FIELD OF THE INVENTION

The present invention is related to a light plate assembly, and in particular, to a light plate assembly having uniform luminosity and minimal light leakage.

### BACKGROUND OF THE INVENTION

Light plate and/or panel assemblies are known. However, obtaining an illuminated area having a relatively large length-to-width ratio with a uniform luminosity along the length of the illuminated area has been problematic. Furthermore, light leakage from various locations surrounding such an illuminated area has also been problematic. Therefore, a light plate assembly having a relatively narrow and long illuminated area with uniform luminosity and minimal light leakage would be desirable.

### SUMMARY OF THE INVENTION

A light plate assembly having minimal light leakage and uniform luminosity for an illuminated display area having a length-to-width ratio greater than 10:1 is provided. The light plate assembly has a housing and a trough within the housing. The trough has an elongated base surface with a length and a width, the length-to-width ratio of the base surface being greater than 10:1. The trough also has a first end and a second end.

A light source such as a light emitting diode (LED) is located within the trough and may or may not be attached to the elongated base surface at the first end and/or the second end. A reflective strip and a light guide plate are also present within the trough. The reflective strip can extend over the elongated base surface and the light guide plate can extend over the reflective strip.

In some instances, a decal strip extends across the light guide plate and a cover having a base frame and a transparent window located within the base frame extends over the decal strip. The transparent window has an inner surface, an outer surface, and a length-to-width ratio greater than 10:1. The cover can be attached to the housing and enclose the decal strip and/or the light guide plate between the elongated base surface and the inner surface of the transparent window. Also, the cover has an opaque side edge that extends from the base frame to the outer surface of the transparent window and prevents undesired light leakage from the trough of the light plate assembly when the light source is illuminated.

Preferably, when the transparent window is illuminated by the light source, a luminosity variation of less than 20% along the length of the transparent window is observed. More preferably, the luminosity variation is less than 10% along the length of the transparent window. Even more preferably, the luminosity variation is less than 5%, or in the alternative, less than 2%.

The housing can also have a sealing canal surrounding the trough and the cover can have a sealing ridge that extends from an inner surface of the cover into the canal. In some instances, an adhesive can be at least partially present within the canal, and the canal, the sealing ridge and the adhesive provide a water-tight enclosure of the light source, light guide plate and/or decal strip between the housing and the cover. It is appreciated that the opaque side edge can extend from the base frame such that the entire transparent window is bounded by the opaque side edge and light leakage in a generally sideways direction is prevented and/or minimized. In this manner, a relatively compact and leakage-free light plate assembly can be provided and used as a component within a compartment. Such a compartment can be a passenger compartment within a motor vehicle, an airplane, a passenger rail car and the like.

### BRIEF DESCRIPTION OF THE DRAWINGS

FIG. 1 is a perspective view of a dashboard for a motor vehicle containing an embodiment of the present invention;

FIG. 2 is an exploded perspective view of a light plate assembly according to an embodiment of the present invention;

FIG. 3 is an exploded end cross-sectional view of the light plate assembly shown in FIG. 2;

FIG. 4 is an end cross-sectional view of section 4-4 shown in FIG. 1; and

FIG. 5 is a side cross-sectional view of section 5-5 shown in FIG. 2.

### DETAILED DESCRIPTION OF THE PREFERRED EMBODIMENTS

A light plate assembly that provides uniform luminosity and minimal light leakage is provided. As such, the light plate assembly has utility as a component for use in an interior compartment such as a passenger compartment of a motor vehicle.

The light plate assembly has a housing that contains one or more light sources, a reflective strip, a light guide plate and an optional decal strip. In combination with a cover, the light plate assembly provides an illuminated area that has a length-to-width ratio greater than 10:1 and a variation in luminosity along the length of the illuminated area of less than 20%.

The housing can have a trough, i.e. a depression within the housing, that has an elongated base surface with a width and a length. In addition, the length-to-width ratio of the elongated base surface is greater than 10:1. The light source, e.g. a light emitting diode (LED) can be attached to the base surface at a first end and/or a second end of the trough and the reflective strip extends across the elongated base surface between the first end and the second end. The light guide plate can be located over and extend across the reflective strip adjacent to the LED and be operable for light transmitted from one or more LEDs to travel and/or pass therethrough. A decal strip can extend across the light guide plate, and in some instances, a diffuser strip can be located between the light guide plate and the decal strip. It should be appreciated that light exiting the light guide plate illuminates one or more desired locations or areas of the decal strip to provide a desired “look,” message, etc.

A cover with a base frame and a transparent window located within the base frame is included. The transparent window has an inner surface, an outer surface and a length-to-width ratio greater than 10:1. The cover can be attached to the housing and extend across and enclose the light guide plate and/or decal strip between the elongated base surface of the trough and the inner surface of the transparent window. In addition, the cover can have an opaque side edge or surface that extends from the base frame to the outer surface of the transparent window. The opaque side edge prevents light leakage from the trough in a generally sideways direction when the one or more LEDs are illuminated. Stated differently, when the one or more LEDs are illuminated, light desirably escapes in an outward direction through the transparent window, but does not escape in the area or region between the base frame and the outer surface of the transparent window.

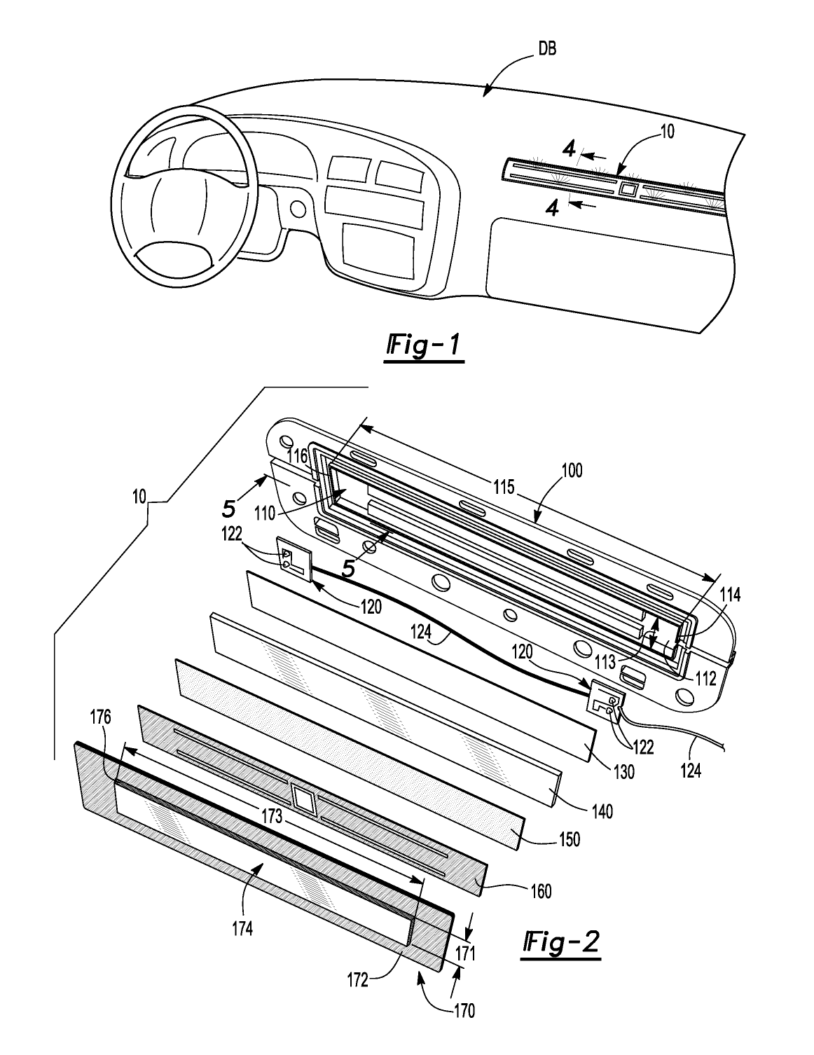

Turning now to FIG. 1, a dash board DB of a motor vehicle is shown with a light plate assembly according to an embodiment of the present invention illustrated at reference numeral 10. It should be appreciated that the light plate assembly 10 can be located at any location within any type of interior compartment or space where an aesthetically pleasing and illuminated decal, window and the like is desired. For example and illustrative purposes only, the dash board DB can represent a door sill plate for a motor vehicle, and overhead compartment in an airplane, passenger rail car, camper, etc. Stated differently, the light plate assembly can be placed at any location where an elongated light plate is desired.

FIG. 2 provides an exploded perspective view of the light plate assembly 10. The light plate assembly 10 can have a housing 100 with a trough 110 therewithin. The trough 110 has a base surface 112. The base surface 112 has a width 113 and a length 115. In addition, the trough 110 has a first end 114 and a second end 116.

Located within the trough 110, is at least one LED assembly 120. The LED assembly can have at least one LED 122 and an electrical line 124 in electrical communication therewith. As known to those skilled in the art, the one or more LEDs 122 can be attached to and/or be part of a printed circuit board as illustrated in the figure. It is appreciated that the LED assembly 120 is located adjacent to, and may or may not be attached to, the base surface 110.

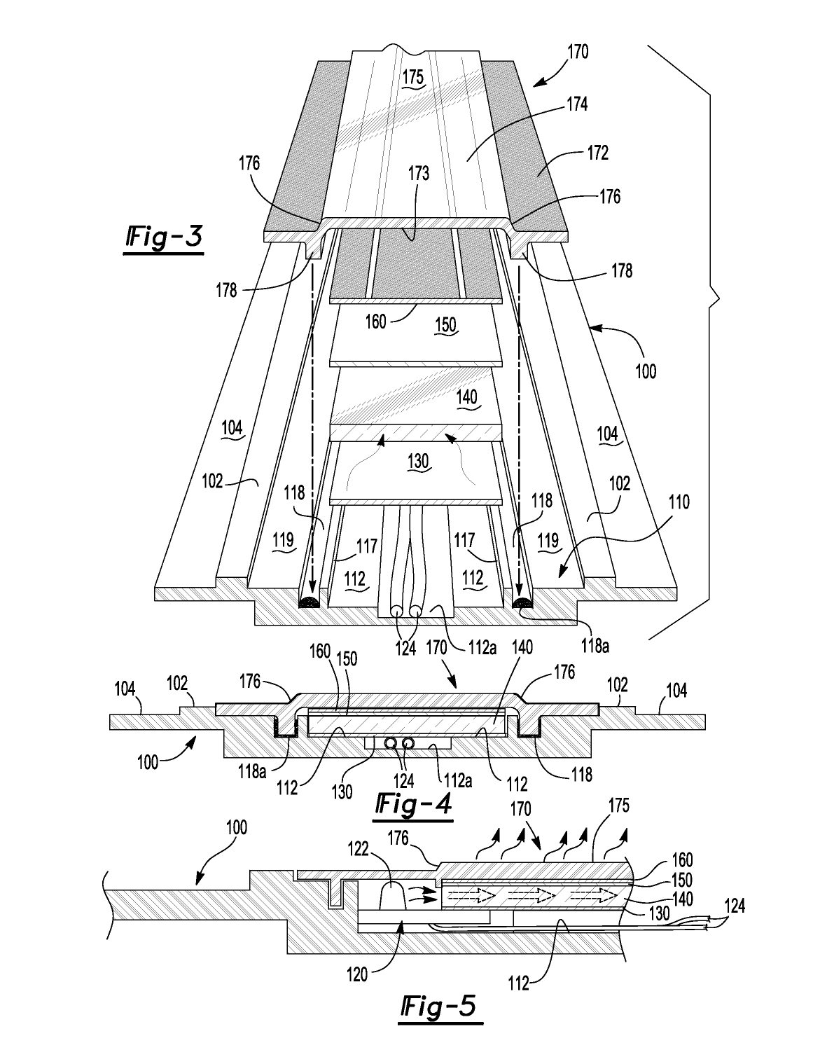

A reflective strip 130 is included and extends across the base surface 112 between the LEDs 122. In some instances, the reflective strip is located behind or beneath the LEDs 122, i.e. between at least one of the LEDs 122 and the base surface 112. In the alternative, the reflective strip 130 has a length such that it fits next to an LED 122, e.g. between the LEDs 122, but on top of an LED circuit board as shown in FIG. 5. It should be appreciated that the reflective strip 130 can be any reflective material known to those skilled in the art that is used as part of a light plate assembly.

Extending over the base surface 112 and the reflective strip 130 is a light guide plate 140. The light guide plate 140 is naturally operable for light to pass therethrough and exit at or along a desired surface. Any light guide plate known to those skilled in the art can be used.

Optionally, a diffuser strip 150 can be included and extend across the light guide plate 140. In addition, a decal strip 160 having a desired decal, design, etc., can be included and extend across the diffuser strip 150.

A cover 170 having a base frame 172 and a transparent window 174 within the parameters of the base frame 172 is included. The cover 170 can be removably or permanently attached to the housing 100 using any fastener, method and/or device known to those skilled in the art. As such, the LED assembly 120, reflective strip 130, light guide plate 140, optional diffuser strip 150 and optional decal strip 160 can be sandwiched between the housing 100 and an inner surface 173 of the transparent window 174.

The transparent window 174 has a width 171, a length 173, and a length-to-width ratio that is greater than 10:1. In some instances, the length-to-width ratio is greater than 12.5:1, while in other instances the length-to-width ratio is greater than 15:1, or in the alternative, greater than 17.5:1.

The cover 170 also has an opaque side edge 176 extending from the base frame 172 to an outer surface 175 of the transparent window 174 (see FIGS. 3-5).

Looking specifically at FIGS. 3-5, the electrical line 124 can be located within a trough wiring channel 112a and a sealing canal 118 can be located between a canal ridge 117 and a trough flange 119. Complimentary with and extending at least partially into the sealing canal 118 can be a sealing ridge 178 that extends from a bottom side or surface of the cover 170. Adhesive 118a can be placed and located at least partially within the sealing canal 118 such that the cover 170 with its sealing ridge 178 provides a water tight compartment for the LED assembly 120, reflective strip 130, light guide plate 140, diffuser strip 150 and decal strip 160. In some instances, the cover 170 can fit within housing ridges 102. Furthermore, the side edges 176 can extend around and bound the transparent window 174.

During operation, light from an LED 122 enters and exits the light guide plate 140, and then passes through the transparent window outer surface 175 as illustrated in FIG. 5. However, the opaque side edge 176 prevents light from escaping from the edges or side regions of the transparent window 174.

As it stated above, the combination of one or more LEDs 122, reflective strip 130, light guide plate 140 and opaque side edge or surface 176 affords for a relatively narrow and long illuminated area with uniform luminosity. The variation of the luminosity can be measured using a luminosity meter at various locations along the length of the window. For example, and for illustrative purposes only, a luminescence meter such as the LS-100 manufactured by Konica Minolta or an ASP-MK350 luminous meter provided by Allied Scientific Pro can be used to take and compare luminescence measurements along the length 173 of the transparent window 174.

It is to be understood that various modifications are readily made to the embodiments of the present invention described herein without departing from the scope and spirit thereof. Accordingly, it is to be understood that the invention is not to be limited by the specific illustrated embodiment, but by the scope of the claims.

1. A light plate assembly comprising:
a housing;
a trough within said housing, said trough having an elongated base surface with a length to width ratio greater than 10:1, said trough also having a first end and a second end;
an LED attached to said base surface at said first end;
a reflective strip within said trough and extending across and substantially covering said base surface;
a light guide plate extending across said reflective strip;
a decal strip extending across said light guide plate; and
a cover having a base frame and a transparent window located within said base frame, said transparent window having an inner surface, an outer surface and a length to width ratio greater than 10:1, said cover attached to said housing and extending across and enclosing said decal strip between said light guide plate and said transparent window inner surface;
said cover also having an opaque side edge extending from said base frame to said outer surface, said opaque side edge preventing light leakage from said trough when said LED is illuminated.

2. The light plate assembly of claim 1, wherein said transparent window is illuminated by said LED and has a luminosity variation less than 20% along said length of said transparent window.

3. The light plate assembly of claim 2, wherein said luminosity variation is less than 10% along said length of said transparent window.

4. The light plate assembly of claim 2, wherein said housing has a canal surrounding said trough and said cover has a sealing ridge extending from said inner surface of said transparent window into said canal, said sealing ridge extending at least partially into said canal.

5. The light plate assembly of claim 4, further comprising an adhesive at least partially within said canal, said canal, said sealing ridge and said adhesive providing a water tight enclosure of said decal strip between said housing and said cover.

6. The light plate assembly of claim 1, wherein said opaque side edge extends from said base frame completely around said transparent window.

7. The light plate assembly of claim 1, further comprising another LED attached to said base surface at said second end.

8. A light plate assembly comprising:
a housing with a light trough therewithin, said light trough having an elongated base surface extending between a first end and a seconds end, said elongated base surface having a length, a width and a length to width ratio greater than 10:1;
an LED at said first end within said light trough;
an electric wire in electrical communication with said LED;
a reflective strip extending across and substantially covering said base surface within said trough;
a light guide plate extending across and substantially covering said reflective strip; and
a cover having a base frame and a transparent window located within said base frame, said transparent window having an inner surface, an outer surface, a length, a width and a length-to-width ratio greater than 10:1, said cover attached to said housing and extending across and enclosing said reflective strip and said light guide plate between said elongated base surface and said transparent window inner surface;
said cover also having an opaque side edge extending from said base frame to said transparent window outer surface, said opaque side edge preventing light leakage from said light trough when said LED is illuminated.

9. The light plate assembly of claim 8, wherein said transparent window is illuminated by said LED and has a luminosity variation less than 20% along said length of said transparent window.

10. The light plate assembly of claim 9, wherein said luminosity variation is less than 10% along said length of said transparent window.

11. The light plate assembly of claim 8, wherein said housing has a canal surrounding said trough and said cover has a sealing ridge extending from said inner surface of said transparent window into said canal, said sealing ridge extending at least partially into said canal.

12. The light plate assembly of claim 11, further comprising an adhesive at least partially within said canal, said canal, said sealing ridge and said adhesive providing a water tight enclosure of said decal strip between said housing and said cover.

13. The light plate assembly of claim 8, wherein said opaque side edge extends from said base frame completely around said transparent window.

14. The light plate assembly of claim 9, further comprising another LED attached to said base surface at said second end.
